(19) United States
(12) Patent Application Publication
(10) Pub. No.: US 2014/0034187 A1
(43) Pub. Date: Feb. 6, 2014

(54) HYDROGEN FILLING STATION SYSTEM AND METHOD OF OPERATION THEREFOR

(71) Applicants: Fred Farchmin, Wendelstein (DE); Manfred Waidhas, Nuernberg (DE); Thomas Wasser, Erlangen (DE); Andreas Wiest, Muehlhausen (DE)

(72) Inventors: Fred Farchmin, Wendelstein (DE); Manfred Waidhas, Nuernberg (DE); Thomas Wasser, Erlangen (DE); Andreas Wiest, Muehlhausen (DE)

(73) Assignee: Siemens Aktiengesellschaft, Muenchen (DE)

(21) Appl. No.: 14/112,602

(22) PCT Filed: Mar. 20, 2012
(86) PCT No.: PCT/EP2012/054876

§ 371 Date: Oct. 18, 2013

(30) Foreign Application Priority Data
Apr. 18, 2011 (DE) 10 2011 017 451.6
Aug. 18, 2011 (DE) 10 2011 081 178.8

(51) Int. Cl. F17C 5/06

(52) U.S. Cl. CPC F17C 5/06
USPC 141/4; 141/71

(57) ABSTRACT

A hydrogen filling station system generates hydrogen on demand. The hydrogen filling station system includes a PEM electrolyzer for generating hydrogen, a compression device for compressing the hydrogen, and a filling system for filling a vehicle with the compressed hydrogen. The required space for the hydrogen filling station system is reduced and operational safety is increased in that the PEM electrolyzer is directly connected to the compression device and the compression device is directly connected to the filling system, without temporary storage respectively. That is, there is no requirement to intermediately store the compressed hydrogen.

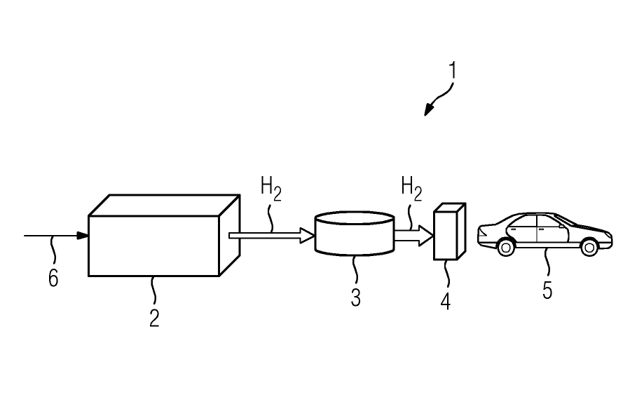

The invention relates to a hydrogen filling station system for generating hydrogen on demand and also to a method of operation for such a hydrogen filling station system.

To establish hydrogen-based mobility, in addition to the vehicles, a supply infrastructure in the form of a filling station system must also be developed. Current conventional filling stations for gasoline/diesel mostly possess underground tanks. For the expansion of these current filling stations (“points of sales”) by the fuel hydrogen all filling stations would have to be equipped with an additional storage tank (additional space requirement) with the corresponding safety approvals, technical tests etc. The fuel is then supplied via a delivery (transport by means of a special vehicle) or via decentralized generation by means of electrolysis. Current examples of hydrogen fuel stations show that, because of the technical framework conditions of the electrolysis technology employed, (alkalitic electrolysis) intermediate storage of the hydrogen generated is absolutely necessary if the desire is to keep the time for filling the vehicle tank to an acceptable level. Typically 5 kg of hydrogen is delivered at 700 bar in three minutes.

Current filling stations for hydrogen (as part of demonstration projects for example) basically consist of the three sections “hydrogen generation”, “hydrogen storage” and “compression and vehicle tank filling system”. The section “hydrogen generation” is either provided centrally (mostly by means of “natural gas or steam reformation”) the hydrogen obtained is then delivered by means of special tankers to the filling stations and stored there (mostly above ground) or it is created on site but then also stored in tanks until it is used.

The underlying object of the invention is to specify a hydrogen filling station system as well as an operating method for such a hydrogen filling station system with which the outlay for apparatus and the space requirement for such a hydrogen filling station system can be reduced and the operational safety can be increased.

The object directed to a hydrogen filling station system is achieved in accordance with the invention by a hydrogen filling station system for generating hydrogen on demand, comprising a PEM electrolyzer for generating hydrogen, a compression device for compressing the hydrogen and a vehicle tank filling system for filling the tank of a vehicle with the compressed hydrogen, wherein the PEM electrolyzer is connected to the compression device and the compression device is connected to the vehicle tank filling system without any intermediate storage in each case.

The object directed to the operating method is achieved in accordance with the invention by a method for operating a hydrogen filling station system for generation of hydrogen on demand, with the following steps
Generation of hydrogen in a PEM electrolyzer
Supplying the generated hydrogen directly and without intermediate storage to a compression device for compressing the hydrogen,
Compressing the generated hydrogen in the compression device,
Supplying the compressed hydrogen without intermediate storage to a vehicle tank filling system for filling the tank of a vehicle with the compressed hydrogen.

The advantages and preferred embodiments given here in relation to the hydrogen filling station system can be transferred equally to the operating method.

With the development of electrolysis based on a PEM (Proton Exchange Membrane) technology and its scaling into the corresponding performance classes, intermediate storage of the generated hydrogen can be dispensed with. Intermediate storage is especially to be understood as an underground or above-ground tank which is filled with surplus hydrogen, wherein the hydrogen is used at a later time, especially after hours or days, for the vehicle tank filling process. The fact that the PEM electrolyzer is connected directly and without intermediate storage to the compression device and the compression device is likewise connected directly and without intermediate storage to the vehicle tank filling system means in this case that as a rule only as much hydrogen is generated by the PEM electrolyzer as is required for the current vehicle tank filling process, so that no surplus hydrogen is stored along the production line between the PEM electrolyzer and the vehicle tank filling system. In the generation and provision of hydrogen on demand the PEM electrolyzer is started up especially at the beginning of the vehicle tank filling process and shut down after the end of the vehicle tank filling process. The volume flow of around 1.5 kg/min specified or needed by the vehicle tank filling process is thus made available directly—without intermediate storage—by the PEM electrolyzer.

In accordance with a preferred variant the hydrogen is generated by the PEM electrolyzer at an initial pressure of 20-75 bar, especially of 30-50 bar. In accordance with a further preferred variant the compression device is embodied for compression of the hydrogen to 700 bar. Preferably the compression device has a compressor tank in such cases, which is connected directly to the vehicle tank filling system. Thus a small auxiliary storage device of the hydrogen above the compressor time is merely necessary as part of the compression device (or compression stage respectively), from which the vehicle tank filling takes place. The compressor tank is an integral component of the compression device in that the compressor tank is especially connected spatially directly to a compressor for compressing the hydrogen. The compressor tank is therefore smaller than the storage tanks currently usual at hydrogen filling stations.

In order to provide the required hydrogen volume flow, the PEM electrolyzer expediently has a maximum power of at least 5.5 MW, especially of a least 4 MW.

The alkalitic electrolysis previously used needs continuous operation and is restricted to the available power, dynamic operation is not possible because of the “thermal inertia”, i.e. start-up time of around 30 minutes until the rated load is reached. By contrast the PEM technology has a start-up time of around 10 seconds (black start) and can thus be switched on for vehicle tank filling and switched off again thereafter.

In addition the PEM technology has the property of being able to be operated on overload (up to 300%). The investment costs on the one hand and the construction volume on the other hand are reduced by this, since a PEM electrolyzer can be constructed as a much more compact unit than an alkalitic electrolyzer with comparable characteristic values.

Because of the market penetration curve to be expected it can be more efficient to equip filling stations without large storage sections. A filling station system consisting of a 2 MW PEM electrolyzer, a further compression stage (to 700 bar) and a vehicle tank filling system without intermediate storage is more flexible in the choice of site and is not dependent on further infrastructure (except for power and water connections).

By producing the hydrogen “on demand” and dispensing with the intermediate storage acceptance benefits are also produced if the site is located in a safety-sensitive environment (residential area).

Expediently the filling station system is of modular construction and has an infrastructure of pipes and valves through which additional components are able to be connected. Thus the possibility exists of expanding the hydrogen filling station system if required by additional components at any time, for example by a storage section being connected. The design and the configuration of the hydrogen filling station system enables a more flexible reaction to the development of the markets and allows the necessary supply infrastructure to be realized more quickly and with fuller coverage.

The FIGURE shows an exemplary embodiment of an inventive filling station system 1 with a PEM electrolyzer 2, a compression device 3, a vehicle tank filling system 4 and a vehicle 5 with a tank to be filled. The PEM electrolyzer 2 has a power of 1.9 MW, an overload capability of up to 300% and a start-up time of around 10 seconds (black start). By means of electrolytic current, which is indicated by the arrow 6, hydrogen H₂ is generated in the PEM electrolyzer 2 at an initial pressure of 30-50 bar. The hydrogen H₂ is fed into the compression device 3 and compressed there to 700 bar. The compressed hydrogen H² is subsequently supplied directly to the vehicle tank filling system 4 and is used for filling the tank of the vehicle 5. The filling station system 1 is characterized in this case by a small space requirement and high operational safety, since the generated hydrogen H₂ is conveyed without intermediate storage to the vehicle tank filling system 4

1-7. (canceled)

8. A hydrogen filling station system for generation of hydrogen on demand, the system comprising:
a proton exchange membrane electrolyzer for generation of hydrogen;
a compression device for compression of the hydrogen to form compressed hydrogen; and
a vehicle tank filling system for filling a tank of a vehicle with the compressed hydrogen;
wherein said PEM electrolyzer is directly connected to said compression device and said compression device is directly connected to said vehicle tank filling system substantially without intermediate storage of the hydrogen and of the compressed hydrogen, respectively.

9. The hydrogen filling station system according to claim 8, wherein an initial pressure of the hydrogen generated in said PEM electrolyzer lies between 20 and 70 bar.

10. The hydrogen filling station system according to claim 9, wherein the initial pressure of the hydrogen generated in said PEM electrolyzer lies between 30 and 50 bar.

11. The hydrogen filling station system according to claim 8, wherein said compression device is configured for compressing the hydrogen to a pressure of 700 bar.

12. The hydrogen filling station system according to claim 8, wherein said compression device has a compressor tank connected directly to said vehicle tank filling system.

13. The hydrogen filling station system according to claim 8, wherein said PEM electrolyzer has a maximum power of 5.5 MW.

14. The hydrogen filling station system according to claim 13, wherein said PEM electrolyzer has a maximum power of 4 MW.

15. The hydrogen filling station system according to claim 8, configured as a modular system with said PEM electrolyzer, said compression device, and said vehicle tank filling system are formed in modular construction and have an infrastructure through which additional components are able to be connected.

16. A method of operating a hydrogen filling station system, the method comprising the following steps:
for generating hydrogen on request, with the following steps:
generating hydrogen upon request in a PEM electrolyzer;
supplying the hydrogen without intermediate storage to a compression device and compressing the hydrogen in the compression device to form compressed hydrogen;
supplying the compressed hydrogen without intermediate storage to a vehicle tank filling system for filling a tank of a vehicle with the compressed hydrogen.
